(19) United States
(12) Patent Application Publication
(10) Pub. No.: US 2009/0231437 A1
(43) Pub. Date: Sep. 17, 2009

(54) TV DATA PROCESSING METHOD AND TV DATA RECEIVER UTILIZING WHICH

(76) Inventor: Yao-Chang Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/046,439

(22) Filed: Mar. 11, 2008

(51) Int. Cl. H04N 17/00; H04N 7/16

(52) U.S. Cl. 348/180; 725/151; 348/E17.001

(57) ABSTRACT

A TV data processing method includes receiving TV data, determining a program type to which the TV data belongs, detecting a signal quality of the TV data, and determining if the signal quality is larger than a threshold standard. When the signal quality is not larger than a threshold standard, the method includes processing the TV data according to the program type. Also, the method according to the present invention can assign different threshold standards to different program types respectively.

### BACKGROUND OF THE INVENTION

1. Field of the Invention

The present invention relates to a TV data processing method and a TV data receiver utilizing which, and particularly relates to a TV data processing method for TV data according to program types thereof and to a TV data receiver utilizing which.

2. Description of the Prior Art

The TV data signal quality of a portable TV system is influenced with the signal strength; in other words, where the receiver locates affect the image quality. A portable TV system will show a warning message such as “No Signal” and will stop displaying when the signal quality is lower than a predetermined threshold standard. However, such a process will bring inconvenience to users, Some types of programs such as sports or movies, usually need to be displayed smoothly, but some types of programs, such as news, talk shows or music, the high image quality is not needed but good audio performance instead. Therefore, the single threshold is not so friendly for a user, and the stop of displaying TV with low signal quality, either. Such issue not only happens when the signal quality is poor but also happens when the frame of TV data can not be smoothly decoded.

### SUMMARY OF THE INVENTION

Therefore, one objective of the present invention is to provide a TV data processing method that processes TV data according to different program types of the TV data, when the signal quality of TV data is lower than a threshold standard.

One embodiment of the present invention discloses a TV data processing method, which comprises: (a) receiving TV data; (b) determining a program type to which the TV data belong; (c) detecting a signal quality of the TV data; (d) determining if the signal quality is larger than a threshold standard; and (e) when the signal quality meets the threshold standard, processing the TV data according to the program type. Also, this embodiment can assign threshold standards to different program types respectively.

Another embodiment of the present invention discloses a TV data receiver, which comprises: a processing unit, for receiving TV data and for determining a program type to which the TV data belong; and a signal quality determination module, couple to the processing unit, for detecting a signal quality of the TV data and for determining if the signal quality is larger than a threshold standard; wherein when the signal quality determination module determines that the signal quality is not larger than the threshold standard, the processing unit processes the TV data according to the program type. Besides, this embodiment can assign threshold standards to different program types respectively.

Via the above-mentioned embodiments, TV data with different program types can be processed in different ways. Also, different threshold standards can be assigned to different program types. In this way, the convenience of a user can increase.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating part of the steps of a TV data processing method according to an embodiment of the present invention.

FIG. 2 is a flowchart illustrating part of the steps of a TV data processing method according to an embodiment of the present invention.

FIG. 3 is a schematic diagram illustrating the examples of settings of the TV data processing method according to an embodiment of the present invention.

FIG. 4 is a block diagram illustrating a TV data receiver according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

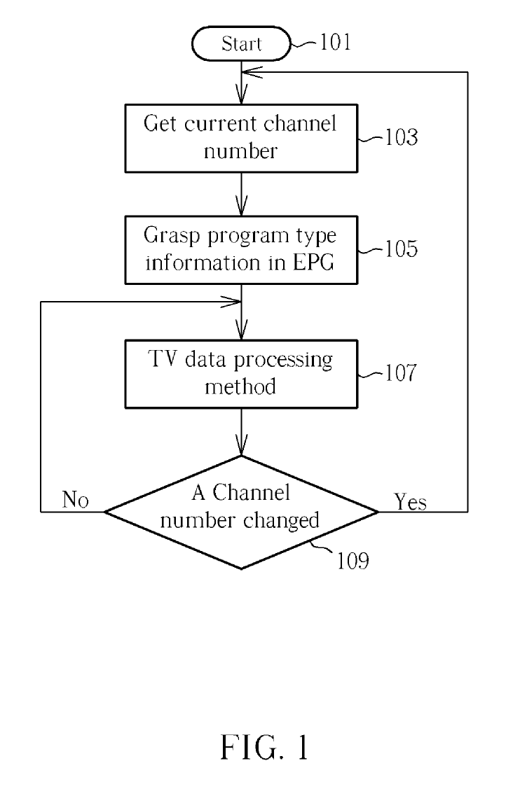

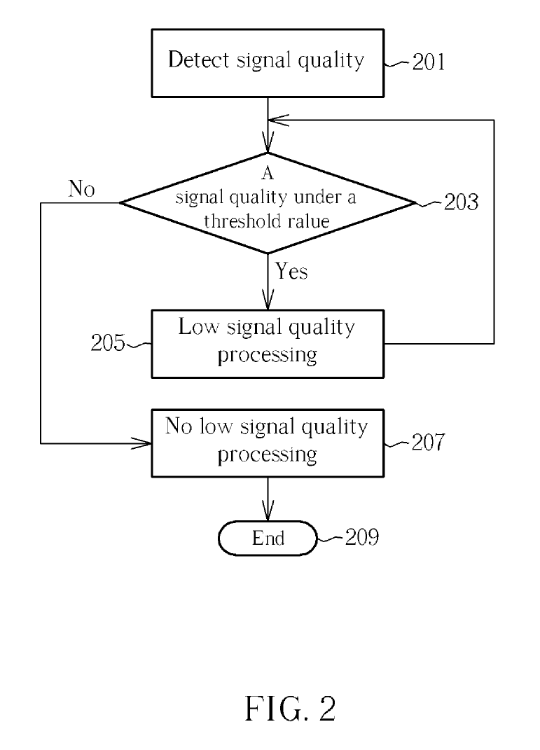

FIG. 1 and FIG. 2 are flowcharts illustrating part of the steps of a TV data processing method according to an embodiment of the present invention. Please jointly refer to FIG. 1 and FIG. 2 to understand the present invention more clearly. Please note that DTV (digital TV) data is utilized as an example in the embodiment, but it does not restrict to use only digital TV data in the present invention. Any kind of TV data including individually transmitted audio data and video data can be applied.

As shown in FIG. 1, the TV data processing method includes step 101-105.

After Step 105, a TV data processing method according to an embodiment of the present invention, which is shown in FIG. 2, is performed in step 107, and the step 107 is performed until the channel number is changed. The step 109 is used for determining if the channel number is changed. If the channel number is changed, Steps 103 and 105 are performed again.

The TV data processing method shown in FIG. 2 includes steps 201-209. The steps 201˜209 are repeatedly performed until the channel number is changed.

In step 205, since the program type is obtained in the step 105 in FIG. 1, the present invention can perform different processes that are described below on TV data of different program types respectively. The present invention can assign different threshold standards to different program types respectively. In this embodiment, the step 201 detects the frame recognizing percentage that indicates the percentage that the frame can be recognized by human eyes after decoded. If the frame can be perfectly recognized, it is 100%, and a lower value means a more poor signal quality. Also, the present invention assigns different threshold standards to different program types respectively means that different values to see if the frame recognizing percentage thereof is lower than the frame recognizing percentage. However, signal qualities can also be determined by other methods. For example, a SNR (Signal Ratio Rate) rate of the TV data signal can also be detected to determine the signal quality.

Besides, the TV data is DTV data in this embodiment, and the program type is grasped from the EPG of the DTV data. However, not only DTV data can be utilized for the present invention: TV data having both video and audio data transmitted can be utilized for the present invention. Also, the program type can be grasped by other ways other than from the EPG.

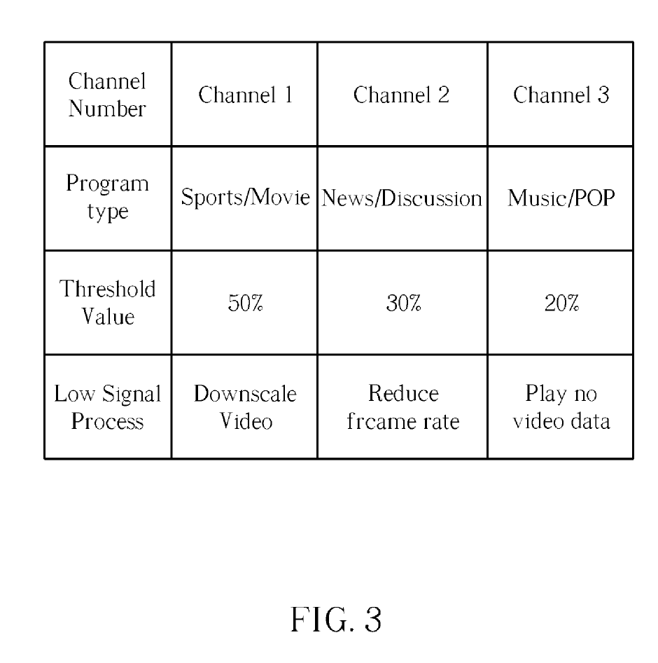

FIG. 3 is a schematic diagram illustrating the examples of settings of the TV data processing method according to an embodiment of the present invention. As shown in FIG. 3, the program types of ch1, ch2 and ch3 are respectively sport/soccer, news/discussion, and music/pop. Also, the threshold standards corresponding to ch1, ch2 and ch3 are 50%, 30%, and 20%. Besides, the low signal processes corresponding to ch1, ch2 and ch3 are respectively downscale video; reduce frame rate; and play no video data.

Since TV data with a program type such as a sports or a movie always need high performance video data such that a user will not lose any frames. Therefore, such TV data will be assigned a high threshold standard (50% in this embodiment). Also, the low signal process will, in this case, downscale the video in such that the frames of the TV data can still be displayed smoothly and completely, without losing any frames.

Additionally, TV data with a program type such as News/ Discussion does not need high performance of video data—that is, the tolerance for lost or blurred frames is higher than for sports/movie—but good performance audio data is needed, so that a user can clearly understand the content via voices thereof. Thus, such TV data will be assigned a medium threshold standard (30% in this embodiment). Besides, the low signal process will reduce the frame rate in this case, such that the voice can still be smoothly and clearly heard and a user will not lose any valuable content thereof.

Furthermore, if the TV data with a program type of music/pop, it may only need audio and no video, because the video is not important in this exemplary kind of program. Thus, such TV data will be assigned a lowest threshold standard (20% in this embodiment). In addition, the low signal process will display no video data, playing only audio data, such that the audio can be smoothly and clearly heard.

It should be noted that the corresponding relations between threshold standards, low signal quality processing and program types are only examples and not meant to limit the scope of the present invention: other relations can also be applied to the present invention. For example, the sports/movie program can have a threshold standard of 30%, and the low signal process thereof can be to decrease the frame rate.

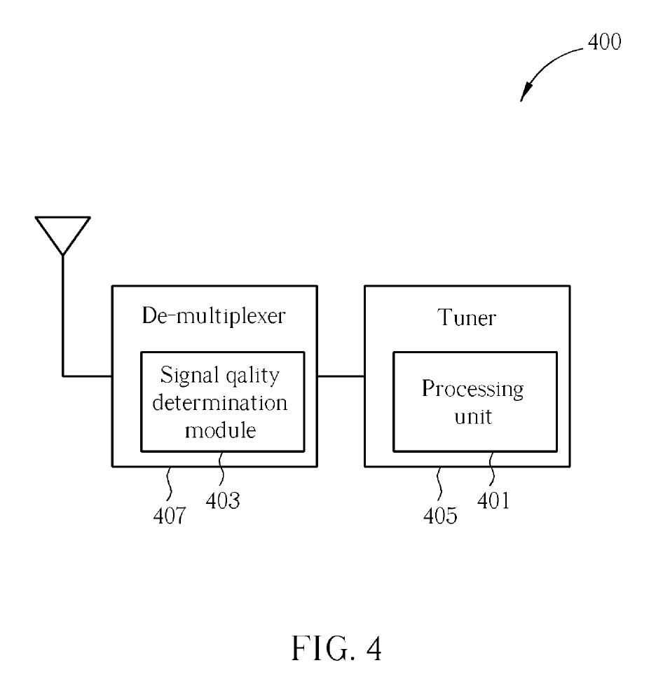

FIG. 4 is a block diagram illustrating a TV data receiver 400 according to an embodiment of the present invention. The disclosed TV data receiver 400 is part of a TV system in this case, and the TV data receiver 400 includes a processing unit 401 and a signal quality determination module 403. The processing unit 401 is for receiving TV data and for determining a program type to which the TV data belongs. The signal quality determination module 403 is for detecting a signal quality of the TV data and for determining if the signal quality is larger than a threshold standard. If the signal quality determination module 403 determines that the signal quality is not larger than the threshold standard, the processing unit 401 processes the TV data according to the program type.

In this case, the TV data receiver 400 comprises a tuner 405 and a de-multiplexer 407. The processing unit 401 is located in the tuner 405, and the signal quality determination module 403 is located in the de-multiplexer 407. In this case, the processing unit 401 can also be used by the tuner 405. It should be noted that the processing unit 401 and the signal quality determination module 403 are not limited to the locations shown in FIG. 4, and that they can also be located in other positions.

Other detailed characteristics are already disclosed in the above-mentioned description, and thus are omitted for brevity.

Via above-mentioned embodiments, TV data with different program types can be processed in different ways. Also, different threshold standards can be assigned to different program types. By this way, the convenience of a user can increase.

Those skilled in the art will readily observe that numerous modifications and alterations of the device and method may be made while retaining the teachings of the invention.

What is claimed is:

1. A TV data processing method, comprising:
(a) receiving TV data;
(b) determining a program type to which the TV data belongs;
(c) detecting a signal quality of the TV data;
(d) determining if the signal quality meets a threshold standards; and
(e) when the signal quality meets the threshold standard, processing the TV data according to the program type.

2. The TV data processing method of claim 1, further comprising assigning different threshold standards to different program types respectively.

3. The TV data processing method of claim 1, wherein the signal quality is one of a frame recognizing percentage and a SNR.

4. The TV data processing method of claim 1, wherein the TV data includes program type information, and the step (b) determines the program type according to the program type information.

5. The TV data processing method of claim 1, wherein the TV data includes individually transmitted audio data and video data.

6. The TV data processing method of claim 5, wherein the TV data is DTV data.

7. The TV data processing method of claim 5, wherein the video data includes a plurality of frames and the step (e) downscales the frames.

8. The TV data processing method of claim 7, wherein the program type is one of a sports program type and a movie program type.

9. The TV data processing method of claim 5, wherein the video data includes a plurality of frames and the step (e) reduces a frame rate for displaying the video data.

10. The TV data processing method of claim 9, wherein the program type is one of a news program type and a discussion program type.

11. The TV data processing method of claim 5, wherein the step (e) does not play video data.

12. The TV data processing method of claim 11, wherein the program type is a music program type.

13. A TV data receiver, comprising:
a processing unit, for receiving TV data and for determining a program type to which the TV data belongs; and
a signal quality determination module, coupled to the processing unit, for detecting a signal quality of the TV data and for determining if the signal quality meets a threshold standard;
wherein when the signal quality determination module determines that the signal quality meets the threshold standard, the processing unit processes the TV data according to the program type.

14. The TV data receiver of claim 13, comprising a tuner and a de-multiplexer, wherein the processing unit is located in the tuner, and the signal quality determination module is located in the de-multiplexer.

15. The TV data receiver of claim 14, wherein the signal quality is one of a frame recognizing percentage and a SNR.

16. The TV data receiver of claim 13, further comprising assigning different threshold standards to different program types respectively.

17. The TV data receiver of claim 13, wherein the TV data includes program type information, and the processing unit determines the program type according to the program type information.

18. The TV data receiver of claim 13, wherein the TV data includes individually transmitted audio data and video data.

19. The TV data receiver of claim 18, wherein the TV data is DTV data.

20. The TV data receiver of claim 18, wherein the video data includes a plurality of frames and the processing unit downscales the frames.

21. The TV data receiver of claim 20, wherein the program type is one of a sports program type and a movie program type.

22. The TV data receiver of claim 18, wherein the video data includes a plurality of frames and the processing unit reduces a frame rate of displaying the video data.

23. The TV data receiver of claim 22, wherein the program type is one of a news program type and a discussion program type.

24. The TV data receiver of claim 18, wherein the processing unit does not play video data.

25. The TV data receiver of claim 24, wherein the program type is a music program type.
